(19) United States
(12) Patent Application Publication
(10) Pub. No.: US 2023/0281787 A1
(43) Pub. Date: Sep. 7, 2023

(54) IMAGE GENERATION DEVICE, IMAGE GENERATION METHOD, AND PROGRAM

(71) Applicant: MITSUBISHI HEAVY INDUSTRIES, LTD., Tokyo (JP)

(72) Inventor: Hiroshi TAKEMOTO, Tokyo (JP)

(21) Appl. No.: 18/011,907

(22) PCT Filed: Aug. 26, 2020
(86) PCT No.: PCT/JP2020/032124

§ 371 Date: Dec. 21, 2022

(51) Int. Cl. G06T 7/00; G06T 7/50; G06T 7/90; G06V 10/60; G06V 20/70

(52) U.S. Cl. CPC G06T 7/0008; G06T 7/50; G06T 7/90; G06V 10/60; G06V 20/70; G06T 2207/10024; G06T 2207/20081

(57) ABSTRACT

This image generation device comprises an image generation unit for using an image generation algorithm (AR)—which has been trained on the basis of defect images (PD) that are inspection images showing defects (D) and label images (PL) obtained by adding, to the defect images, labels (Lr) corresponding to the types and shapes of the defects-to input a label image for image generation that has been created through the addition of a desired label to a background image and generate a pseudo-defect image by drawing, on the background image, a pseudo defect corresponding to the label added to the label image for image generation. The image generation unit draws a type of pseudo defect that corresponds to the color of the label.

### TECHNICAL FIELD

The present disclosure relates to an image generation device, an image generation method, and a program.

### BACKGROUND ART

Utilization of AI is being studied in a case where a defect is detected (screened) from an inspection image. In order to correctly detect a defect from a certain inspection image, AI needs to be trained with a sufficient amount of defect images.

In addition, in order to check whether or not a defect is properly detected by the trained screening AI, it is necessary to adjust the detection accuracy or the like, by comparing the detectabilities of the inspector and the screening AI with each other using a test piece into which an artificial defect is inserted.

As a technique related to the above contents, PTL 1 discloses a method for producing an artificial defect material and an FRP structure.

### CITATION LIST

### Patent Literature

[PTL 1] Japanese Unexamined Patent Application Publication No. 2016-090281

### SUMMARY OF INVENTION

### Technical Problem

For the above reason, it is necessary to manufacture a large number of test pieces in order to develop the screening AI, which increases the development cost.

An object of the present invention is to efficiently train a screening AI that detects a defect from an inspection image.

### Solution to Problem

According to one aspect of the present invention, an image generation device includes an image generation unit that by using an image generation algorithm that is trained based on a defect image that is an inspection image, in which a defect is shown, and a label image in which a label corresponding to a type and a shape of the defect is attached to the defect image, inputs a label image for image generation that is generated by attaching a desired label to a background image, and generates a pseudo defect image by drawing a pseudo defect corresponding to the label attached to the label image for image generation, on the background image, in which the image generation unit draws a type of pseudo defect corresponding to color of the label.

Further, according to one aspect of the present invention, an image generation method includes a step of, by using an image generation algorithm that is trained based on a defect image that is an inspection image, in which a defect is shown, and a label image in which a label corresponding to a type and a shape of the defect is attached to the defect image, inputting a label image for image generation that is generated by attaching a desired label to a background image and generating a pseudo defect image by drawing a pseudo defect corresponding to the label attached to the label image for image generation, on the background image, in which in the step of generating the pseudo defect image, a type of pseudo defect corresponding to color of the label is drawn.

Further, according to one aspect of the present invention, a program causes a computer to execute a step of, by using an image generation algorithm that is trained based on a defect image that is an inspection image, in which a defect is shown, and a label image in which a label corresponding to a type and a shape of the defect is attached to the defect image, inputting a label image for image generation that is generated by attaching a desired label to a background image and generating a pseudo defect image by drawing a pseudo defect corresponding to the label attached to the label image for image generation, on the background image, in which in the step of generating the pseudo defect image, a type of pseudo defect corresponding to color of the label is drawn.

### Advantageous Effects of Invention

According to the above-described image generation device, image generation method, and program, the screening AI that detects a defect from an inspection image can be efficiently trained.

### BRIEF DESCRIPTION OF DRAWINGS

FIG. 1 is a diagram illustrating a configuration of an image generation device according to a first embodiment.

FIG. 2 is a diagram illustrating an example of an inspection according to the first embodiment.

FIG. 3 is a diagram illustrating a training method of an image generation algorithm according to the first embodiment.

FIG. 4 is a diagram illustrating the training method of the image generation algorithm according to the first embodiment.

FIG. 5 is a diagram illustrating the training method of the image generation algorithm according to the first embodiment.

FIG. 6 is a diagram illustrating a processing flow of an image generation unit according to the first embodiment.

FIG. 7 is a diagram illustrating details of the process of the image generation unit according to the first embodiment.

FIG. 8 is a diagram illustrating details of the process of the image generation unit according to the first embodiment.

### DESCRIPTION OF EMBODIMENTS

### First Embodiment

Hereinafter, an image generation device according to a first embodiment will be described in detail with reference to FIGS. 1 to 7.

### (Configuration of Image Generation Device)

FIG. 1 is a diagram illustrating a configuration of an image generation device according to a first embodiment.

The image generation device 1 according to the first embodiment shown in FIG. 1 is a device capable of pseudo-generating a defect image necessary for training the screening AI.

In the present embodiment, the screening AI is an AI that receives an ultrasonic inspection image for a structure used in, for example, an aircraft, or the like, as an input, and detects a defect from the inspection image. Further, the image generation device 1 according to the present embodiment is a device that draws a pseudo defect with respect to an ultrasonic inspection image of a normal portion of the structure, and generates a pseudo defect image by ultrasonic inspection.

As shown in FIG. 1, the image generation device 1 includes an image generation unit 10, which is a CPU, a memory 11, an output device 12, an input device 13, and a recording medium 14.

The image generation unit 10 is implemented by operating the CPU according to a program prepared in advance. The processing content of the image generation unit 10 will be described later.

The memory 11 is a so-called main storage device, and provides a storage area necessary for the operation of the CPU 10.

The output device 12 is a so-called liquid crystal display monitor, a speaker, or the like.

The input device 13 is an input device such as a mouse, a keyboard, and a touch sensor.

The recording medium 14 is a large-capacity auxiliary storage device such as an HDD or an SSD. In the present embodiment, the image generation algorithm AR that has been trained in advance is recorded.

The image generation algorithm AR is an image generation AI that is trained, in the training stage, based on a pair of a defect image that is an inspection image, in which an actual defect is shown, and a label image (described later) with a label corresponding to the type and shape of the defect. The above-described image generation unit 10, by using the image generation algorithm AR, draws a pseudo defect corresponding to the label on the background image, from the label image for image generation in which the background image of the good portion is labeled, and generates a pseudo defect image.

In the present embodiment, it is assumed that the image generation algorithm AR is pix2pix, which is an image generation algorithm using a Generative Adversarial Network (GAN). pix2pix can generate, from one image, the other image that is paired with the one image, by training the relationship between two paired images.

In another embodiment, the image generation algorithm AR is not limited to pix2pix, and may be another algorithm having the same function.

### (Example of Inspection for Structure)

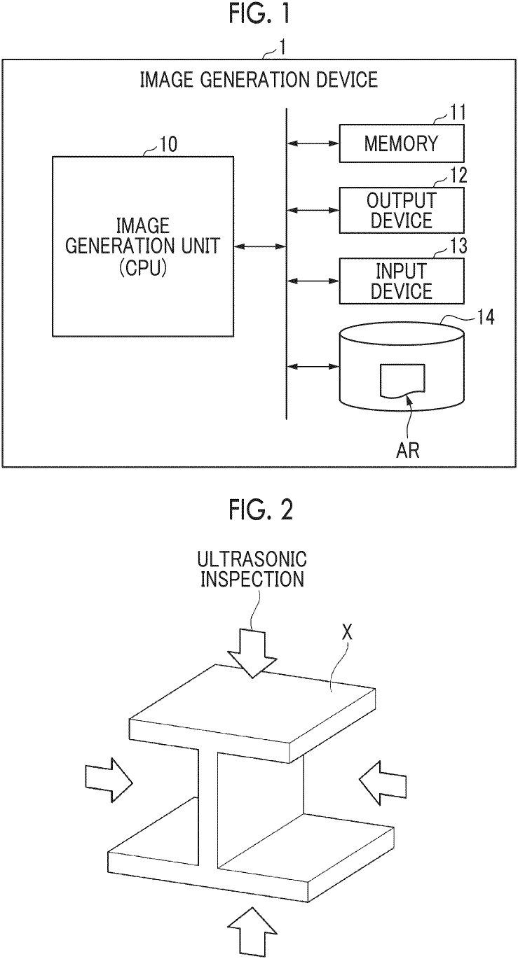

FIG. 2 is a diagram illustrating an example of the inspection according to the first embodiment.

As shown in FIG. 2, in the present embodiment, ultrasonic inspection is performed on the structure X to be inspected from each of the up, down, left, and right directions, and an inspection image thereof is acquired. In the ultrasonic inspection, in one inspection direction, a plurality of types of images are also acquired in the layer direction (depth direction).

The above-described screening AI is required to properly detect defects (at the same level as the determination of the inspector) in all the inspection images acquired in this way.

### (Training Method of Image Generation Algorithm)

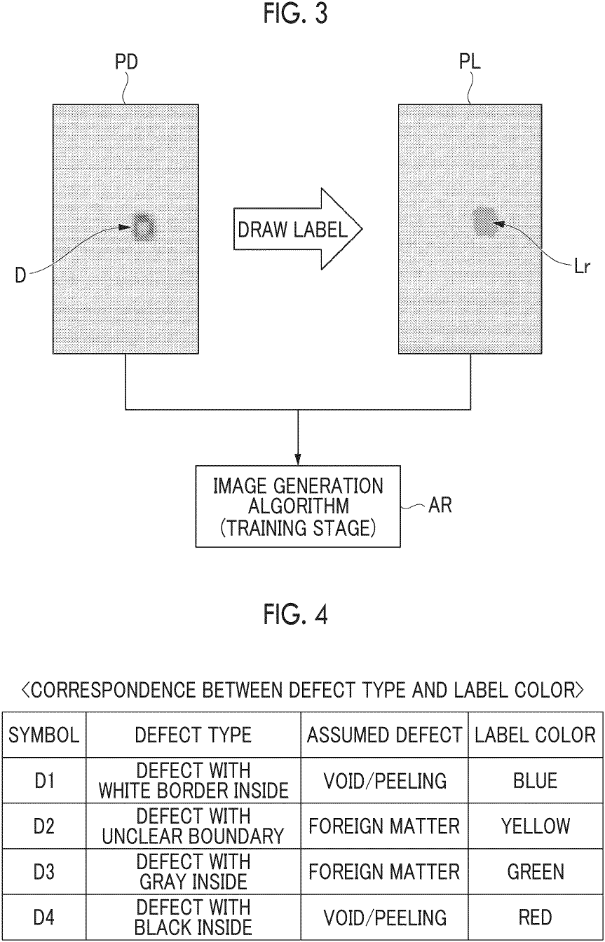

FIGS. 3 to 5 are diagrams illustrating a training method of an image generation algorithm according to the first embodiment.

A prior training method for the image generation algorithm AR will be described in detail with reference to FIGS. 3 to 5.

In the inspection by an ordinary inspector, a test piece (criteria sample) in which a defect is artificially formed is prepared corresponding to the structure X (FIG. 2) to be inspected. Usually, a plurality of types of defects are formed in the test piece, and each of the defects formed therein is a sample of a defect to be detected by an inspector with respect to the structure X.

In the present embodiment, the image generation algorithm AR is trained using a pair of a defect image PD that is an inspection image (an inspection image in which a defect to be detected is shown) of the test piece and a label image PD in which a label corresponding to the type and shape of the defect is attached to the defect image PL.

For example, in the example shown in FIG. 3, a label image PL with a red label Lr is generated for the defect image PD in which the defect D in the test piece is shown. The color (red) of the label Lr is determined according to the type of the defect D displayed on the defect image PD. In addition, the shape (vertically long shape) of the label Lr is determined according to the shape of the defect D displayed on the defect image PD (to have the same shape).

In the training stage, a large number of pairs of such defect images PD and label images PL are prepared, and the correspondence thereof is trained.

FIG. 4 shows an example of the correspondence between the type of defect and the color of the label.

As shown in FIG. 4, corresponding label color (red, blue, yellow, and green) is defined for each of defects D1 to D4 of different types (“defect with black inside”, “defect with white border inside”, “defect with unclear boundary”, and “defect with gray inside”).

Further, in the present embodiment, in the training stage of the image generation algorithm AR, training is performed in consideration of the background pattern of the defect image PD.

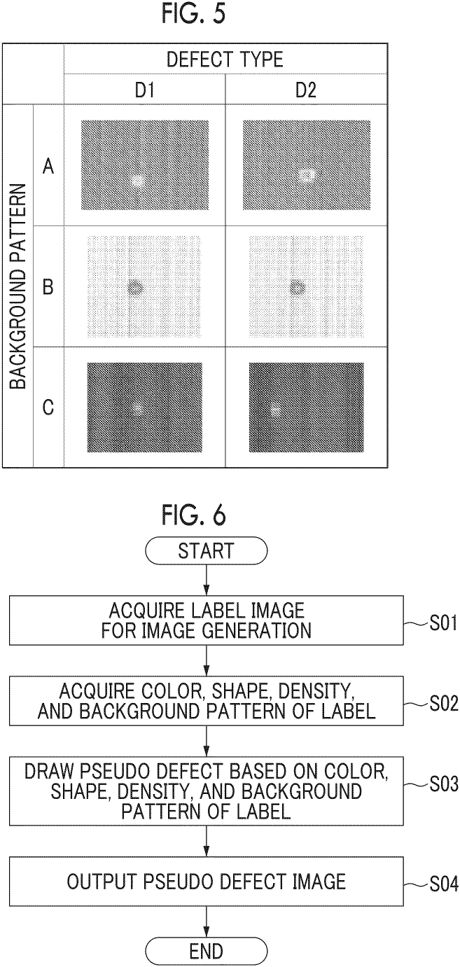

FIG. 5 shows how each of the defect D1 (void/peeling) and the defect D2 (foreign matter) appears for each background pattern (A, B, C). As shown in FIG. 5, even if the defects are of the same type, the appearance is such that the hue is different for each background pattern.

Therefore, in the present embodiment, when the image generation algorithm AR is trained, training is performed while classifying the pair of the defect image PD and the label image PL by the background pattern (A, B, C). By doing so, when drawing a pseudo defect (for example, the defect D1) corresponding to a certain label color (for example, blue) on the background image, the image generation algorithm AR can draw a pseudo defect matching the background pattern (A, B, C) of the background image.

### (Processing Flow of Image Generation Unit)

FIG. 6 is a diagram illustrating a processing flow of the image generation unit according to the first embodiment.

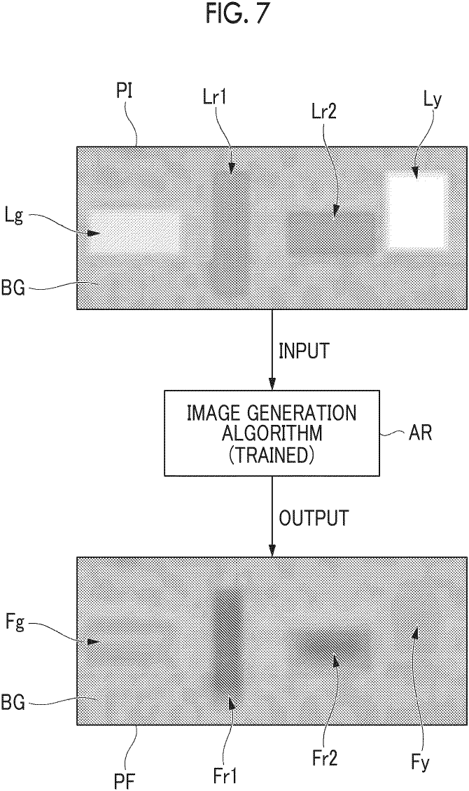

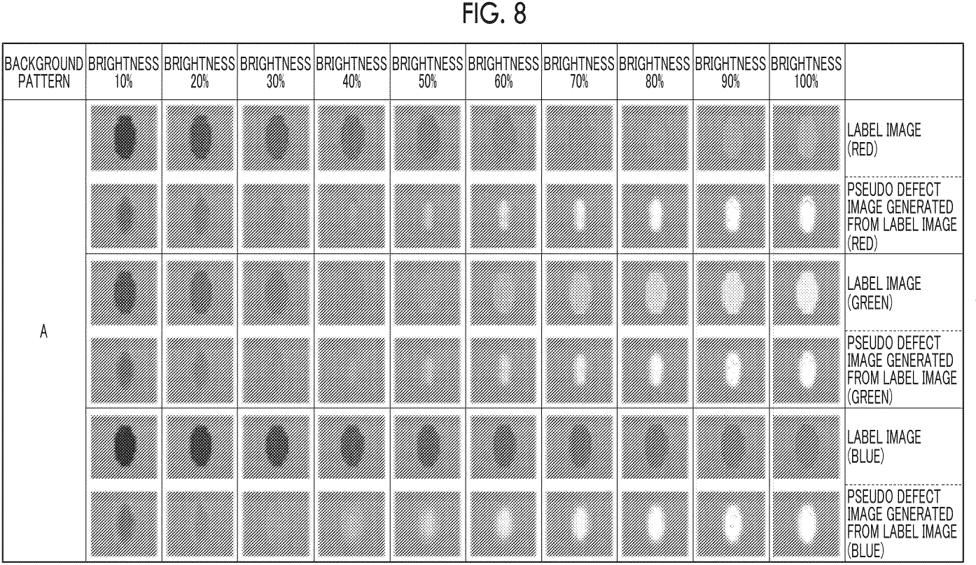

In addition, FIGS. 7 and 8 are diagrams showing details of the process of the image generation unit according to the first embodiment.

Hereinafter, the process of the image generation unit 10 using the trained image generation algorithm AR will be described in detail with reference to FIGS. 6 to 8.

First, the image generation unit 10 acquires a label image for image generation (step S01). Here, the label image for image generation is an image in which a desired label is attached to a background image having no defects by processing.

As a specific example, the label image PI for image generation shown in FIG. 7 is generated by attaching a green label Lg, red labels Lr1, Lr2, and a yellow label Ly to a background image BG in which a defect is not shown.

Returning to FIG. 6, the image generation unit 10 then inputs the label image for image generation acquired in step S01 into the image generation algorithm AR. The image generation algorithm AR reads the input label image for image generation, and acquires the color, shape, density, and background pattern of the label existing in the image (step S02).

Subsequently, the image generation algorithm AR draws a pseudo defect according to the color, shape, density, and background pattern of the label (step S03). Then, the image generation unit 10 outputs a pseudo defect image, which is an image in which the pseudo defects corresponding to the labels are drawn (step S04).

In the pseudo defect image PF shown in FIG. 7, a pseudo defect Fg having “defect with gray inside” is drawn corresponding to the label color (green) of the label Lg of the label image PI for image generation. Further, in the pseudo defect image PF, pseudo defects Fr1 and Fr2 having “defect with black inside” is drawn corresponding to the label color (red) of the labels Lr1 and Lr2 of the label image PI for image generation. Further, in the pseudo defect image PF, a pseudo defect Fy which is “defect with unclear boundary” is drawn corresponding to the label color (yellow) of the label Ly of the label image PI for image generation.

Further, in the pseudo defect image PF, pseudo defects having a hue matching the background pattern of the background image BG are drawn.

Next, with reference to FIG. 8, a function of drawing pseudo defects having different brightness depending on the brightness of the label will be described.

The image generation algorithm AR according to the present embodiment draws a pseudo defect of the brightness corresponding to the brightness of the label attached to the label image PI for image generation. Specifically, as shown in FIG. 8, when the brightness of the label is changed from 10% to 100%, the brightness of the pseudo defect drawn according to the label is also adjusted in the range of 10% to 100%. Accordingly, the brightness of the pseudo defect drawn on the pseudo defect image PF can be controlled based on the brightness of the color of the label attached to the label image for image generation. That is, the user can generate an arbitrary pseudo defect based on the RGB value of the label.

### (Action, Effect)

As described above, the image generation device 1 (image generation unit 10) according to the first embodiment draws the pseudo defect of the type (for example, “defect with black inside”, “defect with white border inside”, “defect with unclear boundary”, and “defect with gray inside”) of the color (for example, “red”, “blue”, “yellow”, and “green”) of the label attached to the label image PI for image generation.

In this way, it is possible to generate a pseudo defect image in which a desired type of pseudo defect is drawn, simply by a user selecting a label color and attaching a label.

Therefore, since a plurality of types of pseudo defect images can be used without requiring a large number of test pieces, the screening AI can be efficiently trained.

In addition, the image generation device 1 (image generation unit 10) according to the first embodiment draws a pseudo defect corresponding to a combination of a pattern (A, B, C) of a background image in the label image PI for image generation and a label.

By doing so, it is possible to draw a pseudo defect matching the background image for each background pattern.

In addition, the image generation device 1 (image generation unit 10) according to the first embodiment draws pseudo defects having different brightness, corresponding to the brightness of the label attached to the label image PI for image generation.

In this way, the brightness of the pseudo defect to be drawn can be controlled as desired by adjusting the RGB value.

In addition, in the first embodiment (and modification example), the procedures of various processes of the image generation device 1 described above are stored in a computer-readable recording medium in the form of a program, and the above various processes are performed by the program being read and executed by the computer. Further, the computer-readable recording medium is a magnetic disk, a magneto-optical disk, a CD-ROM, a DVD-ROM, a semiconductor memory, or the like. Further, this computer program may be distributed to a computer via a communication line, and the computer receiving the distribution may execute the program.

The program may be for implementing a part of the above-described functions. Further, the program may be a so-called difference file (difference program), which can implement the above-described functions in combination with a program already recorded in the computer system.

In addition, it is possible to appropriately replace the components in the above-described embodiments with known components without departing from the spirit of the present invention. It should be noted that the technical scope of the present invention is not limited to the above-described embodiments, and various modifications can be made without departing from the spirit of the present invention.

### Additional Notes

The image generation device 1, the image generation method, and the program described in each embodiment are understood as follows, for example.

(1) The image generation device (1) according to a first aspect includes an image generation unit (10) that by using an image generation algorithm (AR) that is trained based on a defect image (PD) that is an inspection image, in which a defect is shown, and a label image (PL) in which a label corresponding to a type and a shape of the defect is attached to the defect image (PD), inputs a label image (PI) for image generation that is generated by attaching a desired label to a background image, and generates a pseudo defect image (PF) by drawing a pseudo defect corresponding to the label attached to the label image (PI) for image generation, on the background image, in which the image generation unit (10) draws a type of pseudo defect corresponding to color of the label.

(2) In the image generation device (1) according to a second aspect, the image generation unit (10) draws a pseudo defect corresponding to the combination of the pattern of the background image and the label.

(3) In the image generation device (1) according to a third aspect, the image generation unit (10) draws a pseudo defect having different brightness, corresponding to brightness of the label.

(4) The image generation method according to a fourth aspect includes a step of, by using an image generation algorithm AR that is trained based on a defect image that is an inspection image, in which a defect is shown, and a label image in which a label corresponding to a type and a shape of the defect is attached to the defect image, inputting a label image for image generation that is generated by attaching a desired label to a background image and generating a pseudo defect image by drawing a pseudo defect corresponding to the label attached to the label image for image generation, on the background image, in which in the step of generating the pseudo defect image, a type of pseudo defect corresponding to color of the label is drawn.

(5) A program according to a fifth aspect causes a computer to execute a step of, by using an image generation algorithm AR that is trained based on a defect image that is an inspection image, in which a defect is shown, and a label image in which a label corresponding to a type and a shape of the defect is attached to the defect image, inputting a label image for image generation that is generated by attaching a desired label to a background image and generating a pseudo defect image by drawing a pseudo defect corresponding to the label attached to the label image for image generation, on the background image, in which in the step of generating the pseudo defect image, a type of pseudo defect corresponding to color of the label is drawn.

### INDUSTRIAL APPLICABILITY

According to the above-described image generation device, image generation method, and program, the screening AI that detects a defect from an inspection image can be efficiently trained.

### REFERENCE SIGNS LIST

1: image generation device
10: image generation unit
11: memory
12: output device
13: input device
14: recording medium
AR: image generation algorithm

1. An image generation device comprising:
an image generation unit that by using an image generation algorithm that is trained based on a defect image that is an inspection image, in which a defect is shown, and a label image in which a label corresponding to a type and a shape of the defect is attached to the defect image, inputs a label image for image generation that is generated by attaching a desired label to a background image, and generates a pseudo defect image by drawing a pseudo defect corresponding to the label attached to the label image for image generation, on the background image, wherein
the image generation unit draws a type of pseudo defect corresponding to color of the label.

2. The image generation device according to claim 1, wherein
the image generation unit draws a pseudo defect corresponding to a combination of a pattern of the background image and the label.

3. The image generation device according to claim 1,wherein
the image generation unit draws a pseudo defect having different brightness, corresponding to brightness of the label.

4. An image generation method comprises:
a step of, by using an image generation algorithm that is trained based on a defect image that is an inspection image, in which a defect is shown, and a label image in which a label corresponding to a type and a shape of the defect is attached to the defect image, inputting a label image for image generation that is generated by attaching a desired label to a background image and generating a pseudo defect image by drawing a pseudo defect corresponding to the label attached to the label image for image generation, on the background image, wherein
in the step of generating the pseudo defect image, a type of pseudo defect corresponding to color of the label is drawn.

5. A program causing a computer to execute:
a step of, by using an image generation algorithm that is trained based on a defect image that is an inspection image, in which a defect is shown, and a label image in which a label corresponding to a type and a shape of the defect is attached to the defect image, inputting a label image for image generation that is generated by attaching a desired label to a background image and generating a pseudo defect image by drawing a pseudo defect corresponding to the label attached to the label image for image generation, on the background image, wherein
in the step of generating the pseudo defect image, a type of pseudo defect corresponding to color of the label is drawn.
